(19) United States
(12) Patent Application Publication
(10) Pub. No.: US 2019/0003957 A1
(43) Pub. Date: Jan. 3, 2019

(54) METHOD FOR THERMAL CONTROL DURING SURFACE PLASMON RESONANCE ANALYSIS

(71) Applicant: Pall Corporation, Port Washington, NY (US)

(72) Inventors: David Wesley Goad, Stillwater, OK (US); Marcus Jeanfreau Lagrone, Oklahoma City, OK (US); Aaron David Martin, Oklahoma City, OK (US)

(73) Assignee: Pall Corporation, Port Washington, NY (US)

(21) Appl. No.: 16/067,438

(22) PCT Filed: Jan. 6, 2017
(86) PCT No.: PCT/US17/12519

§ 371 Date: Jun. 29, 2018

Related U.S. Application Data
(60) Provisional application No. 62/287,249, filed on Jan. 26, 2016.
(60) Provisional application No. 62/276,625, filed on Jan. 8, 2016.

(51) Int. Cl. G01N 21/03; G01N 21/552

(52) U.S. Cl. CPC G01N 21/0332; G01N 2201/0231; G01N 21/553

(57) ABSTRACT

Disclosed is an SPR sensor which includes a thermally controlled biosensor. Additionally, the current disclosure describes SPR techniques which include the step of heating the SPR sensor to temperatures greater than ambient temperature.

### CROSS REFERENCE TO RELATED APPLICATIONS

This Application claims the benefit of Provisional Patent Application No. 62/276625 filed on Jan. 8, 2015 and the benefit of Provisional Patent Application No. 62/287249 filed on Jan. 26, 2015.

### STATEMENT REGARDING FEDERALLY SPONSORED RESEARCH OR DEVELOPMENT

This invention was made with government support under SBIR Fast-Track Award Number R44TR000618 awarded by National Institutes of Health, National Center for Advancing Translational Sciences. The government has certain rights in the invention.

### BACKGROUND

Surface plasmon resonance (SPR) is an analytical method routinely used to examine interaction of molecules, particularly biomolecular interactions, and measurement of molecular association and dissociation rates, affinity constants and other characteristics associated with molecular interaction or binding events. In simplest terms, surface plasmon resonance is a technique for detecting changes in refractive index at the surface of a sensor. The sensor (10) comprises a glass substrate (12) and thin noble metal coating (14) (e.g., gold, silver, etc.). With reference to FIG. 1, polarized light passes through the substrate and reflects off the gold coating. At certain angles of incidence, a portion of the light energy couples through the gold coating and creates a surface plasmon wave (16) at the interface between the sample and the gold surface. The angle of incident light required to sustain the surface plasmon wave is very sensitive to changes in refractive index at the surface (18), due to mass change. These changes in refractive index are used to monitor the association and dissociation of biomolecules.

The SPR effect is extremely sensitive to temperature. Temperature changes of less than 1° C. can cause a dramatic shift in SPR response. Therefore, precise control of assay thermal parameters is essential.

### SUMMARY

In one embodiment, the present disclosure describes a biosensor system. The biosensor system comprises an optically clear substrate having a first side and a second side, the first side carries a conductive thin metal film with a pair of conductive electrodes in contact with the conductive thin metal film and an optical prism positioned adjacent to the second side of the optically clear substrate. Additionally, the biosensor system includes a block having a recessed area defining a flow channel. The block is positioned adjacent to the first side of the optically clear substrate such that the block and the first side of the optically clear substrate define a flow cell. Further, the biosensor system includes a light source positioned to illuminate the second side of the optically clear substrate, by passing light through the optical prism and a detector apparatus positioned to receive light reflected from the second side of the optically clear substrate. Still further, the biosensor system includes a source of direct current electricity connected to the pair of conductive electrodes.

Additionally the present disclosure describes a SPR sensor cassette. The sensor cassette comprises a glass substrate supporting a thin metal film, a pair of electrodes in contact with the thin metal film and a temperature sensor in contact with the glass substrate or the thin metal film.

Still further, the present disclosure describes a biosensor system which comprises a SPR sensor cassette suitable for docking or insertion into an SPR instrument. The SPR sensor cassette comprises a glass substrate supporting a thin metal film, a pair of electrodes in contact with the thin metal film and a temperature sensor in contact with the glass substrate or the thin metal film. The SPR instrument comprises a port configured to receive said SPR sensor cassette. With the SPR sensor positioned in the port, the SPR instrument provides an optical prism positioned in contact with the glass substrate of the SPR sensor cassette. Additionally, the SPR instrument includes a light source configured to direct light at the glass substrate of the SPR sensor cassette when the SPR sensor cassette is positioned within the port and a detector positioned to receive light reflected from the glass substrate of the SPR sensor cassette when the SPR sensor cassette is positioned within the port. The SPR sensor instrument also provides a source of direct current electricity in electrical contact with the pair of electrodes when the SPR sensor cassette is positioned within the port. Further, the SPR sensor instrument provides a controller configured to receive data from the temperature sensor when the SPR sensor cassette is positioned within the port and configured to manage flow of electrical current to the pair of electrodes,

Additionally, the present disclosure provides methods for performing SPR analysis. The methods include the steps of:

providing a thermally controlled biosensor system, the thermally controlled biosensor system comprising:
an optically clear substrate having a first side and a second side, the first side carrying a conductive thin metal film, the conductive thin metal film being resistant to conductive oxidation;
a pair of conductive electrodes in contact with the conductive thin metal film;
an optical prism positioned adjacent to the second side of the optically clear substrate;
a block having a recessed area defining a flow channel positioned adjacent to the first side of the optically clear substrate;
a flow cell defined by the first side of optically clear substrate and the block;
a light source positioned to illuminate the second side of the optically clear substrate, by passing light through the optical prism;
a detector apparatus positioned to receive light reflected from the second side of the optically clear substrate;
a source of direct current electricity connected to the pair of conductive electrodes;
a temperature sensor probe positioned to monitor the temperature of the flow cell defined by the first side of optically clear substrate and the block;

attaching a surface modification compound to the first side of conductive thin metal film; establishing a baseline temperature for the flow cell;

flowing an analyte through the flow cell while monitoring SPR response;

adjusting the temperature of the flow cell by passing direct current electricity from the source of direct current electricity through the pair of electrodes; and,

continuing to monitor SPR response during the step of adjusting the temperature of the flow cell.

### BRIEF DESCRIPTION OF THE DRAWINGS

FIG. 1 is a simplified schematic of Surface Plasmon Resonance (Kretschmann configuration).

FIG. 2A depicts in a perspective view the fundamental components of one embodiment of a thermally controlled biosensor.

FIG. 2B depicts an overhead view of the conductive electrodes (3) in contact with the metal film (2) with the electrodes connected to a variable DC current source (4).

FIG. 3 depicts a thermally controlled biosensor.

FIG. 4A depicts a thin film heating cassette.

FIG. 4B depicts a side view of the thin film heating cassette.

FIG. 5 is a graph showing SPR response and chip temperature change in response to application of increasing current.

FIG. 6 is a graph showing protein preconcentration on a COOH₅ sensor before and after thin film heating (TFH) procedure.

FIG. 7A is a graph depicting the interaction of carbonic anhydrase II with 1 μM Acetazolamide. Interaction is at a set instrument analysis temperature of 13.4 C. The dashed line is the SPR response curve and the solid line is a fitted model for calculating binding and affinity data.

FIG. 7B is a graph depicting the interaction of carbonic anhydrase II with 1 μM Acetazolamide. Interaction is at increased instrument analysis temperature of 30 C using TFH. The dashed line is the SPR response curve and the solid line is a fitted model for calculating binding and affinity data.

FIG. 8A is a graph depicting the automated stepping of SPR analysis temperature during a single injection using fast transition settings. The stepping profile allowed for some temperature overshoot and more aggressive temperature control at each setpoint. The transition time between steps was ˜2 seconds.

FIG. 8B is a graph depicting the automated stepping of SPR analysis temperature during a single injection. The stepping profile was adjusted to avoid temperature overshoot. In this experiment, stable 5° C. temperature transitions were achieved within ˜10 seconds.

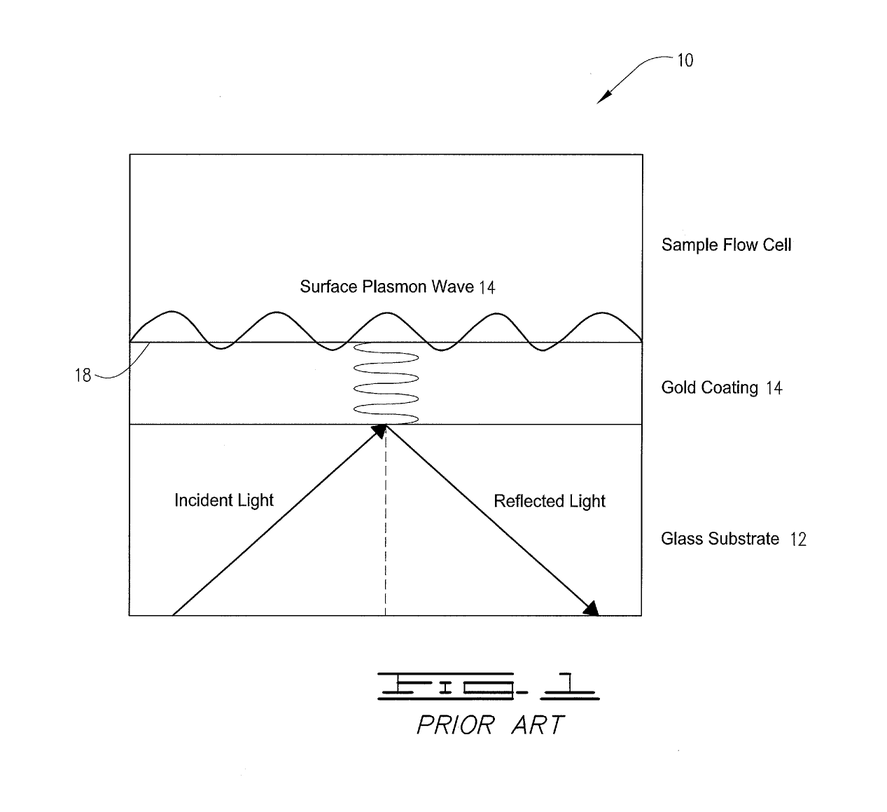

### DETAILED DESCRIPTION

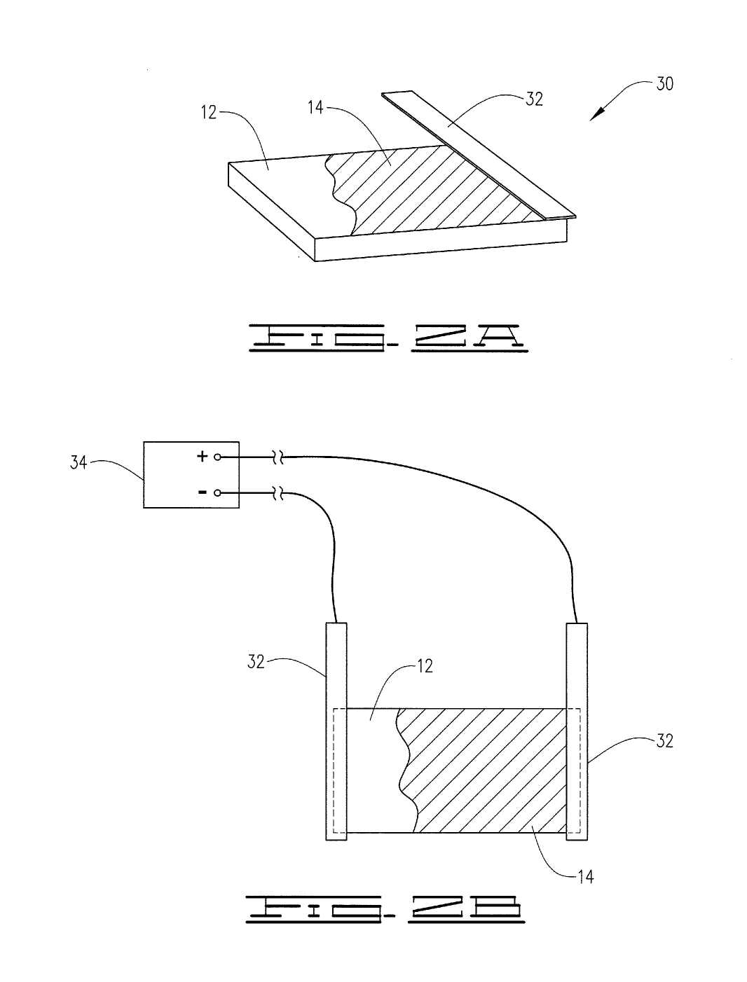

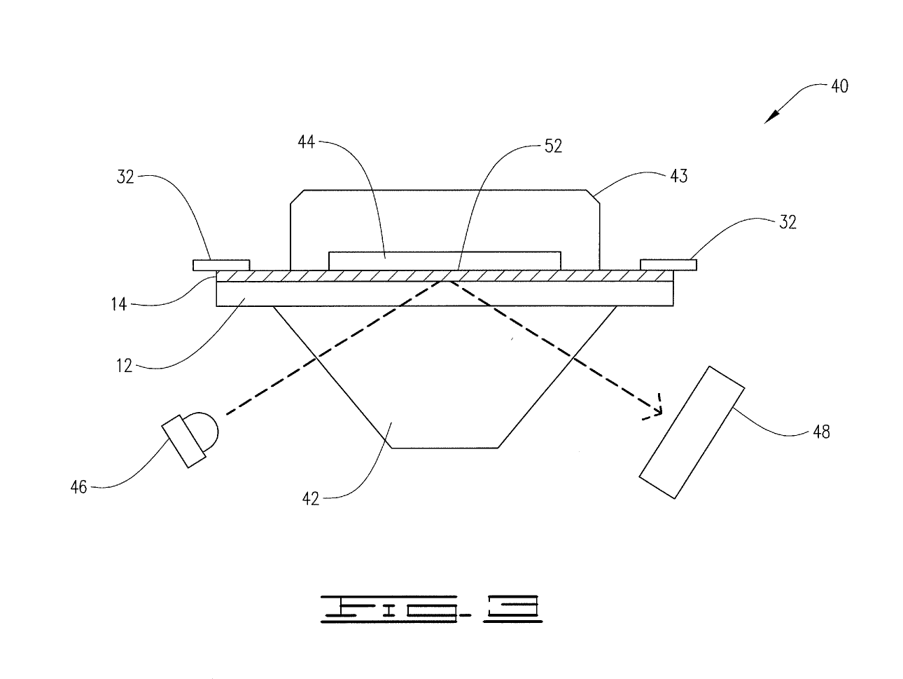

FIGS. 2A and 2B provide a view of the fundamental components of one embodiment of a biosensor chip (30) used in the methods discussed below. An optically clear substrate such as, but not limited to, glass (12) is coated with or carries a conductive thin metal film (14). The thin film may be gold, silver or other metal having resistance to conductive oxidation and utility in SPR analysis. Biosensor chip (30) also carries conductive electrodes (32) which contact metal film (14). FIG. 2B illustrates conductive electrodes (32) in contact with metal film (14) in an overhead view. Connection of electrodes (32) to a variable DC current source (34) provides a circuit for passing electrical current through thin metal film (14).

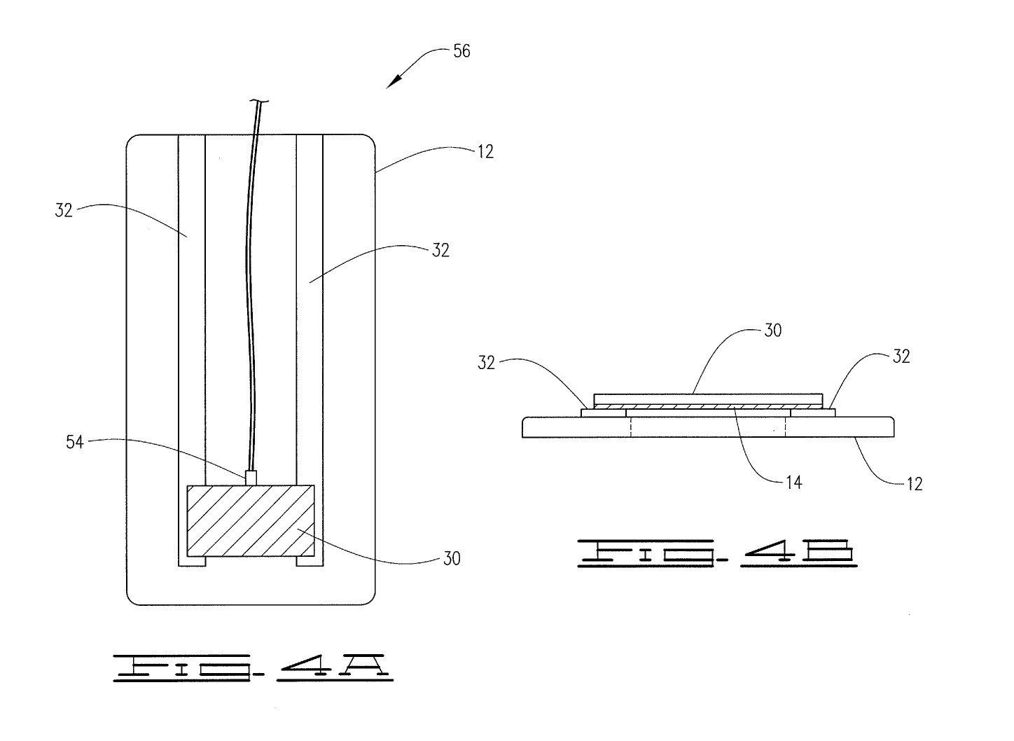

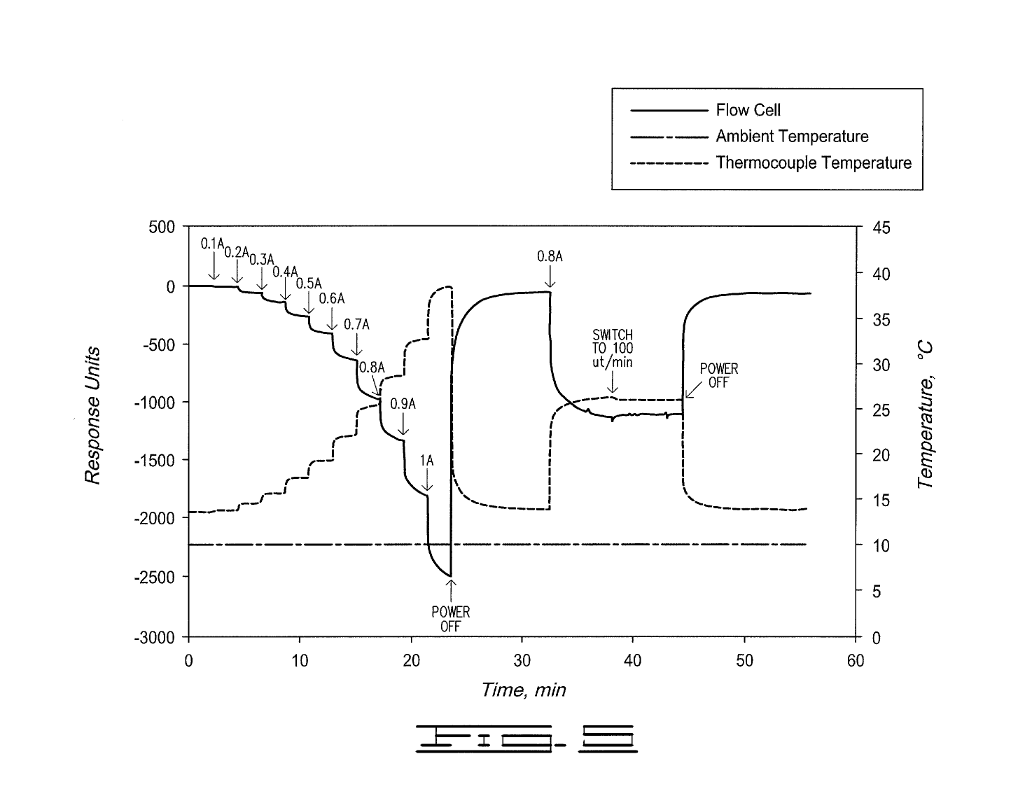

A simplified embodiment of a thermally controlled biosensor system (40) suitable for practicing the disclosed method is shown in FIG. 3. As depicted in FIG. 3, biosensor chip 30 is held between an optical prism (42) and a block (43). Block (43) has a recessed area defining a flow channel. Thus, surface (18), i.e. biosensing surface (52), and block (43) cooperate to define a flow cell (44). A light source (46) illuminates metal film (14), with reflected light striking a detector apparatus (48). Flow cell (44) defines an approximate volume of about one microliter. Thus, heating of metal film (14) permits rapid thermal changes in flow cell (44). The attachment of biomolecules (not shown) to surface (18) provides the SPR biosensing surface (52). As depicted in FIG. 4A, a temperature sensor (54) can be included to permit monitoring of temperature at biosensing surface (52) and within flow cell (44). Temperature sensor (54) may be attached at surface (18) of biosensor chip (30) or secured to block (43) or any other convenient location which permits direct monitoring of temperature within flow cell (44) or at biosensing surface (52). Temperature sensor (54) may be a thermocouple, a thermistor or other suitable sensor for monitoring temperature and providing data to a controller.

During SPR analysis, DC current of about 0.1 amps to about 1.5 amps passes through electrodes (32) and metal film (14) in a controlled manner. The electrical current heats metal film (14) via thin film resistive heating. Accordingly, the heating of metal film (14) also heats the biomolecules (not shown) attached to the biosensing surface (52) side of metal film (14) to a preselected temperature above ambient temperature during SPR analysis. Additionally, controlled variation of the electrical current permits adjustment, either up or down, of the temperature during SPR analysis. When using thermocouple probe (54), thermally controlled biosensor system (40) also provides for control of electrical current to biosensor chip (30) by adjusting electrical current to maintain the desired target temperature in response to variations in temperature detected by thermocouple probe (54). Automatic observation and control of temperature, using thermocouple probe (54), can be achieved through a controller (not shown). A wide variety of options are available for the controller including but not limited to use of a micro-controller reading temperature via an A/D converter and in cooperation with a proportional-integral-derivative (PID) control loop determining the target output current necessary to maintain or achieve the desired temperature. Upon determination of target output current, the controller sets the desired electrical current using a D/A converter connected to an op-amp power stage.

Thermally controlled biosensor system (40) provides simultaneous thermal control and SPR analysis of molecular interactions occurring at biosensing surface (52) of metal film (14). Surface modifications of biosensing surface (52), such as, but not limited to, the attachment of biomolecules (e.g. dextran, or other polymers, thiols, active assembled monolayers, etc.) do not adversely affect the ability to provide thermal control to biosensor chip (30). Beneficially, the use of thin metal film (14) permits rapid thermal ramp rates at biosensing surface (52) and within flow cell (44). In most embodiments, the configuration of thermally controlled biosensor system (40) will place conductive electrodes (32) as close as possible to flow cell (44), thereby providing further thermal control at the region experiencing SPR, i.e. biosensing surface (52).

The above described thermally controlled biosensor system (40) provides the ability to conduct SPR analysis at precisely fixed temperatures. Additionally, the method permits rapid adjustment and subsequent establishment of equilibrium of thermal conditions for assays at fixed temperatures. In addition, the method provides the ability to vary temperature in real time during SPR analysis, i.e. during flow of analyte through flow cell (44) over biosensing surface (52), and enables observation/measurement of SPR response while simultaneously changing temperature. The method utilizes biosensor chip (30) described above and applies an electrical current to metal film (14) to generate a localized heating effect of metal film (14). Metal film (14) can be the gold layer itself or an additional conductive film (not shown) located at the SPR interface, i.e. surface (18). The thin-film heating effect is generated in situ in thermally controlled biosensor system (40) and can be incorporated as an SPR assay parameter.

As noted above, the disclosed device and method utilizes a direct current for application of an electrical current through metal film (14). Metal film (14) has a thickness on the order of 50-100 nm thereby provides the necessary level of electrical resistance. As DC current is applied to electrodes (32), the resistance of metal film (14) results in heating of metal film (14) and in turn, the biosensor chip (30), including flow cell (44) and biosensing surface (52) along with any biomolecules attached to biosensing surface (52) above ambient conditions. The extent of the heating effect is in direct relationship to the amount of current applied. Thus, temperature conditions within flow cell (44) can be adjusted by varying the electrical current. One skilled in the art will recognize that many options are available for providing a controlled DC current to electrodes (32) for heating of biosensing surface (52) and flow cell (44). Some non-limiting examples of mechanisms for delivering DC current include, but are not limited to, direct op-amp connection, dedicated current source, voltage controlled mechanisms like a buck converter or PWM duty cycle adjustment.

Performance of the disclosed method includes the initial step of thin-film resistance heating in thermally-controlled biosensor system (40). The method also permits simultaneous control of biosensor surface temperature in conjunction with measurement of SPR response during molecular interaction analysis.

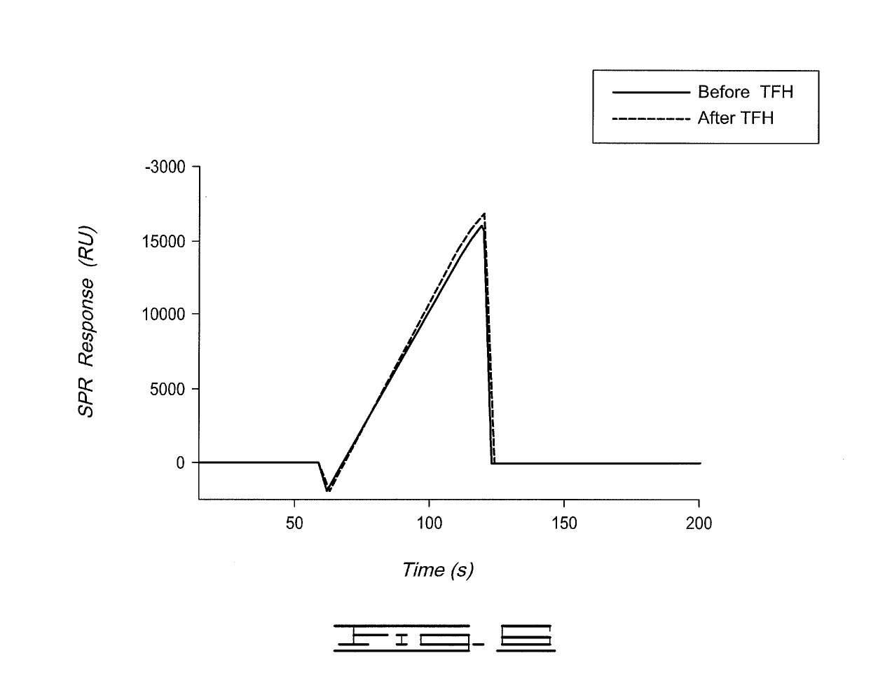

Monitoring of the heating process can be carried out by thermocouple probe (54) or other conventional temperature monitoring device. Total power required to reach ˜30° above ambient temperature is dependent upon starting (ambient) temperature, but is generally less than 5 W. Current can also be applied as a gradient of the range noted above, or can be applied in a stepwise increasing or decreasing manner For example, FIG. 5 depicts a stepwise increase of DC current from 0.1 amp to 1.0 amp in increments of 0.1 amp over a period of about twenty minutes. Although total power level required for a sensor to reach a temperature step will vary according to factors such as sensor surface type, construction, local sensor environment and ambient temperature, rapid upward temperature stepping at ˜5° C. intervals can be achieved in less than 30 seconds from one stable temperature step to another. Thus, stepwise progress from 25° C. to 55° C. would require approximately two minutes to about three minutes.

If the initial temperature of the thermally-controlled biosensor is held below the lowest targeted SPR analysis temperature (e.g., 4° C. versus 10° C. starting analysis temperature) rapid transitions both upward and downward are possible (less than 1 minute transition time for 5° C. stepping). Using a well-controlled power supply (voltage and current) the temperature can theoretically be held at a setpoint indefinitely or until surface oxidation occurs or the metal film is compromised.

However, when using a metal film resistant to electrically-induced oxidation, e.g. a gold film, one would not expect surface oxidation to degrade the SPR functionality of the metallic film. Thus, application of current enables upward adjustment of the temperature of metal film (14) and biosensing surface (52) above the ambient temperature of the surrounding environment. The surrounding environment temperature is typically held constant by a secondary temperature controller (not shown), and at a temperature lower than the desired operational temperatures of biosensing surface (52). Secondary temperature controller can be any convenient cooling system suitable for incorporation in an SPR analysis unit. Reducing or removing electrical current from metal film (14) provides for downward temperature adjustment of biosensing surface (52) by allowing biosensor chip (30) to trend back to the ambient temperature.

Tests were carried out to demonstrate the effectiveness of the disclosed apparatus and methods. To demonstrate the ability to provide in situ thermal control, the concept of thin-film heating was applied to the biosensing surface (52) itself. This test demonstrates that the application of an electrical current applied to gold metal film (14) in a biosensor chip (30) allows gold metal film (14) to function as a localized heat source for fine thermal control. Additionally, this test demonstrates that the application of electrical current to gold metal film (14) permits rapid thermal equilibration of the thermally-controlled biosensor system (40).

Initial benchtop testing using a bare gold metal film (14) and a thermocouple probe (54) indicated the ability to provide thermal control. As current increased, temperature of biosensor chip 30 also increased. With reference to FIGS. 4A and 4B, to characterize the response due to increasing electrical current, a sensor cassette (56) consisting of a thin gold metal film (14) on a glass substrate (12) designed for SPR analysis was modified to include thin foil electrodes (32) at either end of biosensor chip (30) and a fine wire thermocouple probe (54) positioned in contact with the edge of biosensor chip (30). Thus, sensor cassette (56) provides a removable and replaceable biosensor chip (30) suitable for docking with a conventional SPR instrument (not shown). Docking of sensor cassette (56) in a benchtop SPR instrument (not shown) provides all the necessary components of thermally controlled biosensor system 40.

Specifically, docking of sensor cassette (56) results in attachment of electrical leads to electrodes (32) thereby providing the thermally controlled biosensor system (40) of FIG. 3 as the SPR instrument will include block (43), optical prism (42), light source (46) and detector apparatus (48).

Thermocouple probe (54) provides the ability to monitor temperature change of biosensor chip (30). When using sensor cassette (56) in a docked configuration, thermocouple probe (54) will typically be part of the benchtop SPR analysis system and will be incorporated into the block (43) portion of thermally controlled biosensor system (40) or optionally positioned within flow cell (44) or in contact with metal film (14). SPR response and chip temperature were monitored as electrical current to biosensor chip (30) was adjusted. See the graph in FIG. 5. The ambient temperature of the analysis chamber was held at 10° C. As depicted in the first region of FIG. 5 slow stepwise increases in current from 0.1 A to 1 A resulted in slow stepwise increases in temperature with the corresponding change in SPR response. Removal of current as indicated by “Power Off” resulted in SPR response returning to ambient conditions as provided by the secondary controller operation of the cooling system. The second portion of FIG. 5 reflects a single increase in current to 0.8 A and the corresponding change in SPR response.

The results observed, decrease in SPR response units (RU) with increasing temperature over time, were in agreement with temperature/RU relationships previously observed in the SPR analysis system. In addition, the change in measured temperature at the chip edge correlated with change in SPR response. No difference was noted in SPR dip characteristics, and the change in SPR response appears to be solely due to resistance heating of the gold film. These results demonstrate an increase in temperature to approximately 25° C. above ambient sensor temperature. However, in supporting experiments we have successfully reached greater than 75° C. above the ambient 20° C. temperature.

The following examples demonstrate functional thin film heating. These tests were carried out using a biosensor chip (30) described above and depicted in FIGS. 3, 4A and 4B. In this instance, the gold surface of the SPR sensor carried standard COOH5 chemistry. A pre-calibrated fine-wire thermocouple probe was positioned to allow direct contact of the thermocouple junction with the edge of the biosensor chip. Optical film was placed over the assembly and polyimide tape was used to insulate foil electrodes to create a finished assembly. The thermally controlled biosensing chip (30) was docked into a benchtop SPR analysis instrument to provide the thermally controlled biosensing system (40), wiring connections completed and the system was equilibrated at an analysis temperature of 10° C. However, the readings from a thermocouple probe placed in contact with the edge of docked biosensor chip indicated a temperature of 13.4° C. Therefore, 13.4° C. is used as the baseline temperature for experiments described below. Running buffer for all experiments contained 10 mM HEPES pH 7.4, 150 mM NaCl (labeled HBS).

An initial test was performed to determine the effect of thin film heating on the surface chemistry. Fifty μg/mL carbonic anhydrase II (CA-II) in 10 mM acetate buffer (pH 5.0) was pre-concentrated on the sensor chip by injection for 1 min. Then the sensor chip was heated to 39.1° C. using 1 amp of current for 5 min. (˜1.5 V; ˜1.5 W total power). The current was discontinued and the sensor was allowed to equilibrate back to 13.4° C. The CA-II injection was repeated and the pre-concentration signal measured.

Subsequently, a standard amine coupling procedure was used to immobilize the enzyme Carbonic Anhydrase II (CA-II) onto biosensing surface (52) of biosensor chip (30). Approximately 2500 response units (RU) of enzyme were immobilized. An initial test was performed by injecting 1 μM Acetazolamide for one minute at a flow rate of 30 μL/min through flow cell (44) and at the baseline temperature of 13.4° C. Subsequently, the current was increased to 750 mA and the signal allowed to equilibrate for 10 minutes. The Acetazolamide test was repeated at the increased surface temperature. The binding data of Acetazolamide at each temperature was processed according to standard analysis procedures to determine kinetic rate constants and equilibrium dissociation constants. The kinetic rate and equilibrium dissociation constants showed that the increased temperature in the flow cell had the expected effect on the interaction of Acetazolamide binding CA-II. The expected effect referenced is a marked increase in dissociation rate constant and equilibrium dissociation constant with increase in temperature.

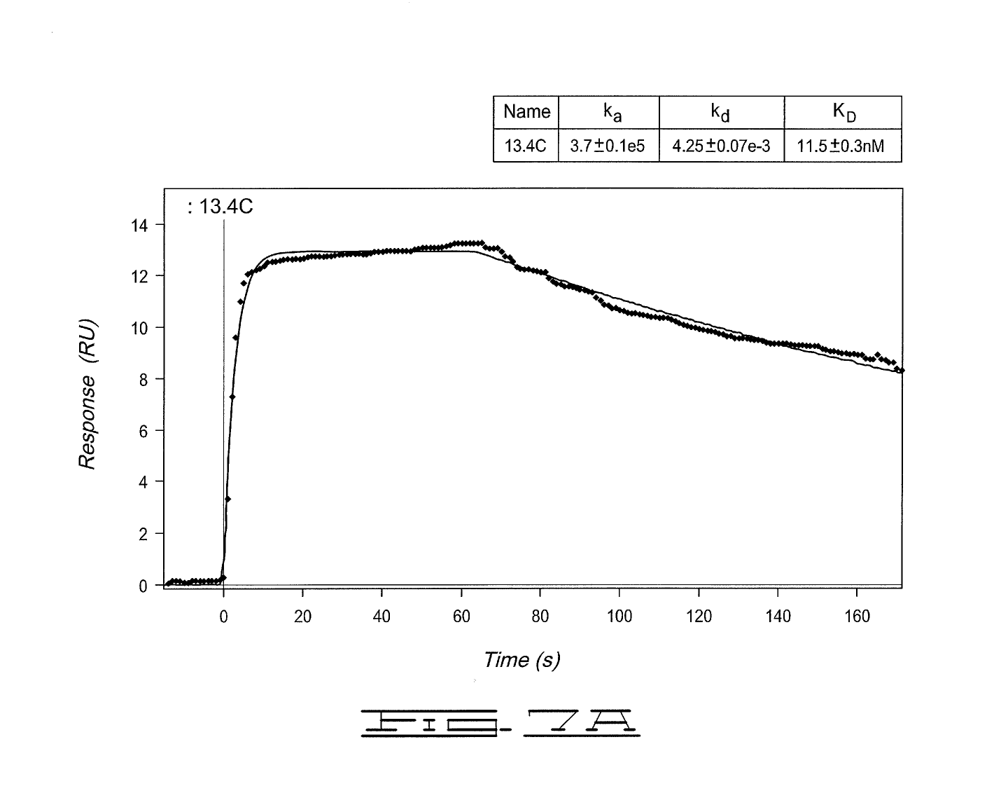

Frequently SPR analysis will require stepwise increases in temperature. The data reported in FIG. 6 demonstrates the ability of the disclosed apparatus and method to provide rapid stepwise increases in temperature during SPR analysis. Using the apparatus of FIGS. 2-4B, an external programmable power supply (not shown) controlled by thermally controlled biosensing system (40) managed electrical current flow to the conductive electrodes (32) thereby managing application of electrical current to metal film (14). In one embodiment, the power supply can be a component incorporated into and controlled by a benchtop SPR unit. Thus, docking of sensor cassette (56) in the benchtop SPR unit provides the thermally controlled biosensor system (40) configured to increase temperature stepwise at defined temperature steps and time intervals during the injection of analyte or other fluid through the SPR sensing zone. Temperature feedback to the SPR instrument necessary for management of the stepwise temperature change and time intervals at the target temperatures was provided by a fine wire thermocouple mounted in the flow cell surface to allow direct contact with the sensor surface outside the microfluidic flow path.

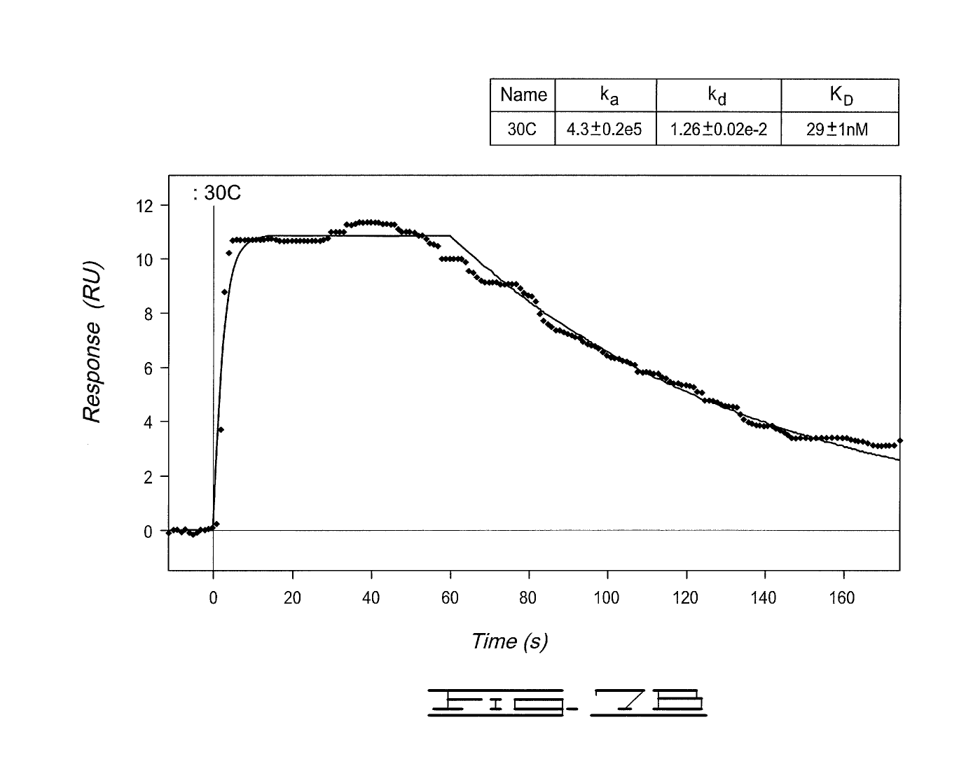

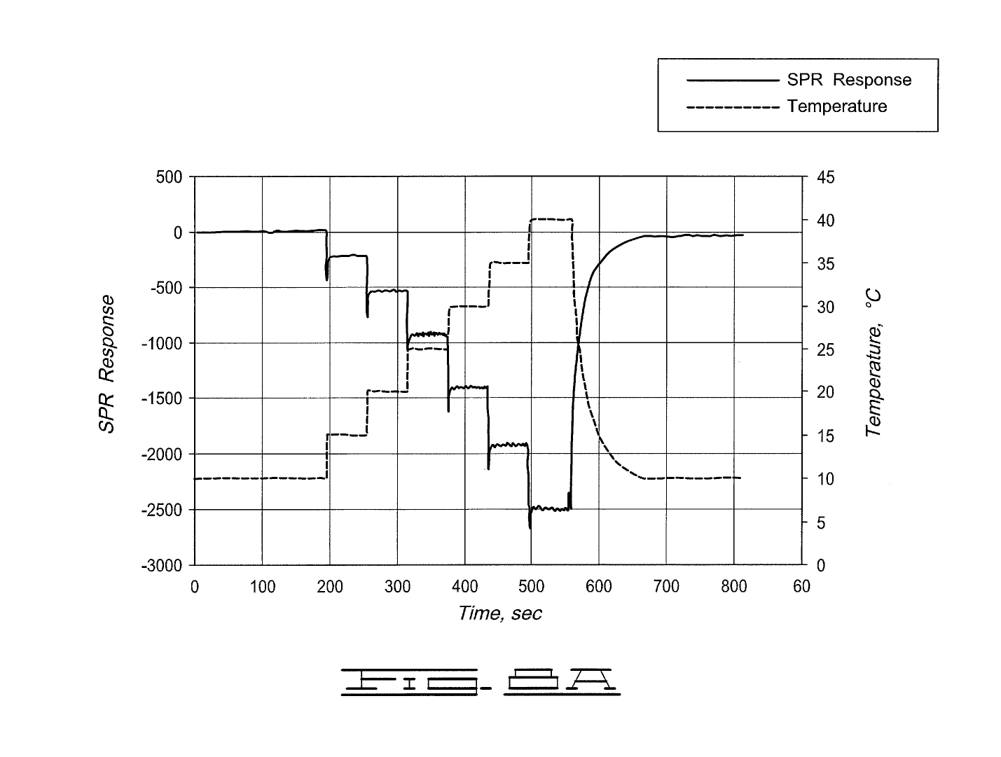

Data shown in FIG. 6 demonstrates that the application of a 1 amp current did not adversely affect the ability to pre-concentrate a protein on biosensing surface (52), as indicated by similar protein preconcentration characteristics before and after TFH. CA-II was then immobilized to test the application of electrical current on an interaction of interest. The results from the Acetazolamide test are shown in FIGS. 7A and 7B.

FIGS. 7A and 7B show the effect of the increased surface temperature on the interaction of Acetazolamide binding CA-II. For this analysis, instrument analysis module temperature was held at 13.4° C., and TFH via application of electrical current to biosensor chip (30) was used to increase temperature of flow cell (44) to 30° C. At the increased temperature of 30° C., FIG. 7B demonstrates that the dissociation rate is clearly increased with a quantitative effect equal to a 5-fold increase in dissociation rate constant relative to 13.4° C. depicted in FIG. 7A. This test served to demonstrate the principle and utility of TFH during SPR analysis.

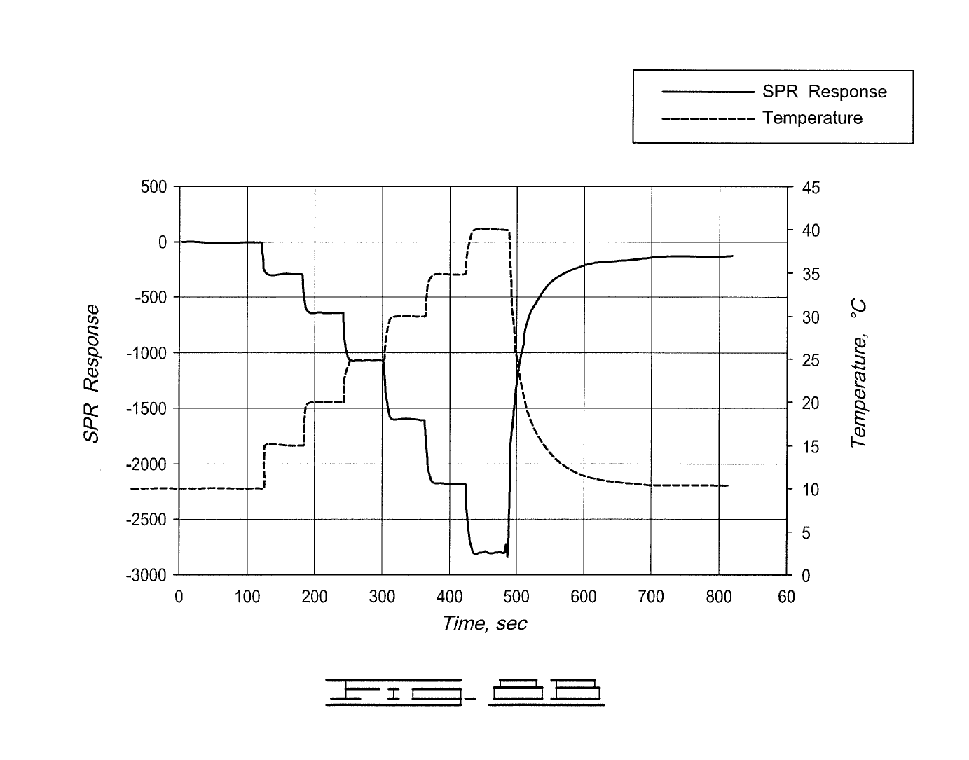

FIGS. 8A and 8B depict the influence of automated temperature increase in a stepwise manner during a continuous injection of analyte through flow cell (44). For these tests, flow rate was set at 50 μ1/min. and both sensor surface temperature and change in SPR response associated with sensor temperature change were monitored. FIG. 8A shows an instrument setting using an aggressive ramp profile with allowance for limited overshooting of temperature set-point at each step. The aggressive stepping profile contributes some noise to the analysis due to higher magnitude of power modulation events. However, FIG. 8A indicates that 5° C. temperature steps at biosensing surface (52) and flow cell (44) can be achieved in 2 seconds or less, with a stable temperature target reached in about 4 seconds. FIG. 8B shows a less aggressive stepping profile which provides a more gradual transition without temperature overshoot. As a result, the graph profile of FIG. 8B has less noise originating from temperature control events. Using these stepping parameters, stable 5° C. temperature transitions can be achieved within 10 seconds while providing a comparatively much cleaner signal. The graphs of FIGS. 8A and 8B clearly demonstrate the capability to rapidly transition temperature during an analyte injection through flow cell (44).

Other embodiments of the present invention will be apparent to one skilled in the art. As such, the foregoing description merely enables and describes the general uses and methods of the present invention. Accordingly, the following claims define the true scope of the present invention.

What is claimed is:

1. A biosensor system comprising:
an optically clear substrate having a first side and a second side, said first side carrying a conductive thin metal film;
a pair of conductive electrodes in contact with said conductive thin metal film;
an optical prism positioned adjacent to said second side of said optically clear substrate;
a block having a recessed area defining a flow channel positioned adjacent to said first side of said optically clear substrate;
a flow cell defined by said first side of optically clear substrate and said block;
a light source positioned to illuminate said second side of said optically clear substrate, by passing light through said optical prism;
a detector apparatus positioned to receive light reflected from said second side of said optically clear substrate; and,
a source of direct current electricity connected to said pair of conductive electrodes.

2. The biosensor system of claim 1, wherein said pair of electrodes contact said conductive thin metal film outside of the flow cell defined by said first side of optically clear substrate and said block.

3. The biosensor system of claim 1, further comprising a temperature sensor positioned to monitor the temperature of said flow cell defined by said first side of optically clear substrate and said block.

4. The biosensor system of claim 3, wherein said temperature sensor is positioned within said flow cell.

5. The biosensor system of claim 3, wherein said temperature sensor is secured to said thin metal film within said flow cell.

6. The biosensor system of claim 3, wherein said temperature sensor is incorporated into said block.

7. The biosensor system of claim 3, further comprising a controller configured to receive input from said temperature sensor and to adjust output of electrical current to said pair of electrode.

8. A SPR sensor cassette comprising:
a glass substrate supporting a thin metal film;
a pair of electrodes in contact with said thin metal film;
a temperature sensor in contact with said glass substrate or said thin metal film.

9. A biosensor system comprising:
a SPR sensor cassette, said cassette comprising:
a glass substrate supporting a thin metal film;
a pair of electrodes in contact with said thin metal film; and,
a temperature sensor in contact with said glass substrate or said thin metal film;
an SPR instrument comprising:
a port configured to receive said SPR sensor cassette;
an optical prism positioned in contact with said glass substrate of said SPR sensor cassette when said SPR sensor cassette is positioned within said port;
a light source configured to direct light at said glass substrate of said SPR sensor cassette when said SPR sensor cassette is positioned within said port;
a detector positioned to receive light reflected from said glass substrate of said SPR sensor cassette when said SPR sensor cassette is positioned within said port;
a source of direct current electricity in electrical contact with said pair of electrodes when said SPR sensor cassette is positioned within said port;
a controller configured to receive data from said temperature sensor when said SPR sensor cassette is positioned within said port and configured to manage flow of electrical current to said pair of electrodes.

10. The biosensor system of claim 9, further comprising a cooling system configured to reduce the temperature of said SPR sensor cassette when said SPR sensor cassette is positioned within said port.

11. A method for performing SPR analysis comprising the steps:
providing a thermally controlled biosensor system, said thermally controlled biosensor system comprising:
an optically clear substrate having a first side and a second side, said first side carrying a conductive thin metal film, said conductive thin metal film being resistant to conductive oxidation;
a pair of conductive electrodes in contact with said conductive thin metal film;
an optical prism positioned adjacent to said second side of said optically clear substrate;
a block having a recessed area defining a flow channel positioned adjacent to said first side of said optically clear substrate;
a flow cell defined by said first side of optically clear substrate and said block;
a light source positioned to illuminate said second side of said optically clear substrate, by passing light through said optical prism;
a detector apparatus positioned to receive light reflected from said second side of said optically clear substrate;
a source of direct current electricity connected to said pair of conductive electrodes;
a temperature sensor probe positioned to monitor the temperature of said flow cell defined by said first side of optically clear substrate and said block;
attaching a surface modification compound to said first side of conductive thin metal film;
establishing a baseline temperature for said flow cell;
establishing a target temperature for said flow cell;
passing sufficient electrical current through said pair of conductive electrodes and said thin metal film to raise the temperature of said flow cell from said baseline temperature to said target temperature.

12. A method for performing SPR analysis comprising the steps:
providing a thermally controlled biosensor system, said thermally controlled biosensor system comprising:
an optically clear substrate having a first side and a second side, said first side carrying a conductive thin metal film, said conductive thin metal film being resistant to conductive oxidation;
a pair of conductive electrodes in contact with said conductive thin metal film;
an optical prism positioned adjacent to said second side of said optically clear substrate;
a block having a recessed area defining a flow channel positioned adjacent to said first side of said optically clear substrate;
a flow cell defined by said first side of optically clear substrate and said block;
a light source positioned to illuminate said second side of said optically clear substrate, by passing light through said optical prism;
a detector apparatus positioned to receive light reflected from said second side of said optically clear substrate;
a source of direct current electricity connected to said pair of conductive electrodes;
a temperature sensor probe positioned to monitor the temperature of said flow cell defined by said first side of optically clear substrate and said block;
attaching a surface modification compound to said first side of conductive thin metal film;
establishing a baseline temperature for said flow cell;
flowing an analyte through said flow cell while monitoring SPR response;
adjusting the temperature of said flow cell by passing direct current electricity from said source of direct current electricity through said pair of electrodes; and,
continuing to monitor SPR response during said step of adjusting the temperature of said flow cell.

13. The method of claim 12, wherein said step of adjusting the temperature achieves a 5° C. increase in temperature in about 10 seconds.

14. The method of claim 12, wherein said step of adjusting the temperature achieves a 5° C. increase in temperature in about 4 seconds.

15. The method of claim 12, wherein said step of adjusting the temperature achieves a 5° C. increase in temperature in about 2 seconds.
